(19) United States
(12) Patent Application Publication
(10) Pub. No.: US 2009/0056591 A1
(43) Pub. Date: Mar. 5, 2009

(54) WEATHER-RESISTANT PEARLESCENT PIGMENTS BASED ON SMALL THIN GLASS PLATES, AND METHOD FOR THE PRODUCTION THEREOF

(76) Inventors: Ulrich Schmidt, Hersbruck (DE); Gunter Kaupp, Neuhaus (DE); Dirk Schumacher, Pegnitz (DE)

Correspondence Address: OSTROLENK FABER GERB & SOFFEN, 1180 AVENUE OF THE AMERICAS, NEW YORK, NY, 100368403, US

(21) Appl. No.: 12/280,202

(22) PCT Filed: Feb. 23, 2007
(86) PCT No.: PCT/EP2007/001603

§ 371 Date: Aug. 21, 2008

(30) Foreign Application Priority Data
Feb. 24, 2006 (DE) 10 2006 009 130.2

(51) Int. Cl. C09C 1/36; C08K 3/22

(52) U.S. Cl. 106/415; 524/403

(57) ABSTRACT

The invention relates to weather-stable pearlescent pigments having improved application properties based on a glass flake coated with highly refractive metal oxides and having a protective coat on its top metal oxide layer.

The pigments of the invention are characterized in that the glass flake exhibits an average thickness of from 50 nm to 500 nm, to which, according to a variant A, a metal oxide layer having a refractive index n greater than 1.8 and containing TiO₂ having a rutile content of from 80% to 100% by weight and a protective coat of SiO₂ are applied, or, according to a variant B, a metal oxide layer having a refractive index n greater than 1.8 and containing TiO₂ having a rutile content of from 80% to 100% by weight and a protective coat comprising a first protective coating containing cerium oxide and/or hydrated cerium oxide and/or cerium hydroxide and a second protective coating of SiO₂ are applied and to the metal oxide layer of the protective coat A or B an organochemical surface coat is applied. The invention also relates to a process for the production of such pigments and to the use thereof.

The present invention relates to weather-stable pearlescent pigments, which have improved application properties and are based on a glass flake coated with highly refractive metal oxides and a protective top coat located on the topmost metal oxide layer. According to a variant A, the pearlescent pigment comprises a thin glass flake to which a highly refractive metal oxide layer containing rutile TiO₂ has been applied followed by a protective top coat of SiO₂, and an organochemical surface coating applied to the SiO₂ layer of the protective top coat. In a second variant B of the invention, the weather-stable pearlescent pigment comprises a thin glass flake to which a highly refractive metal oxide layer containing rutile TiO₂ has been applied, followed by a protective top coat comprising a first protective layer of cerium oxide and/or hydrated cerium oxide and/or cerium hydroxide and a second protective layer of SiO₂, followed by an organochemical surface coating applied to the SiO₂ layer of the protective top coat.

The invention further relates to a process for preparing such pearlescent pigments and also to the use thereof.

Pearlescent pigments comprising titanium dioxide in the top coat or based on particulate TiO₂ possess a certain degree of photocatalytic activity. If, then, UV light acts on a pearlescent pigment in the presence of water and oxygen, the UV activity of the pearlescent pigment may trigger accelerated degradation of organic compounds—a binder matrix, for example. Even the UV fraction present in daylight may cause this reaction. That is to say, for applications such as automobile lacquers, which are directly stressed by weathering, it is necessary to use pearlescent pigments which have been specially stabilized. In order to counter this photocatalytic effect, which is deleterious to exterior applications, pearlescent pigments can be furnished with a variety of protective coatings in order to reduce photoactivity.

Starting from aqueous metal salt solutions, poorly soluble compounds are usually precipitated onto the surface of the pigments, the protective coating containing at least one transition metal, e.g. zirconium, manganese, cerium, or chromium, in addition to oxygen compounds of aluminum or silicon. In order to improve the compatibility of the pigments with various coating materials, in particular with more environmentally friendly water-based systems, an additional organic modification of the top coat is applied using, for example, silanes.

EP 0 141 174 describes pearlescent pigments of improved weather stability which have a protective coating composed substantially of a rare earth metal compound—cerium, for example—and a polysiloxane. Furthermore, the protective coating—the application of which takes place in an aqueous suspension—may also include zinc salts or aluminum salts or alternatively silicate. The coating operation takes place in an aqueous suspension and the product, following isolation thereof, is dried.

DE 2 106 613 describes pearlescent pigments, which comprise mica flakes that are coated with metal oxides and are then immediately coated with a silica layer in an aqueous phase and then calcined. The aim here is to positively influence the optical properties of the pigments such as luster, transparency, and color. However, these pigments are not sufficiently stabilized against UV light.

EP 0 446 986 B1 relates to pearlescent pigments intended for coating applications and having acceptable UV and moisture stabilities due to a smooth, continuous hydrated alumina layer. Using acidic or alkaline aluminum salts, the pearlescent pigments are coated in aqueous phase under controlled conditions and then dried.

EP 0 342 533 discloses zirconium oxide-coated pigments to which it is possible to apply a layer composed of a hydrated metal oxide of cobalt, manganese or cerium. The pigment thus treated is reportedly well suited for use in nonaqueous pigmented coating systems, but it is still unsuitable for water-dilutable pigmented coating systems, according to EP 632 109, since it causes the formation of microfine bubbles in the coated film.

According to the teaching of EP 0 632 109 a three-layer protective coat is applied to a platelet-shaped substrate coated with metal oxides. In a first stage, SiO₂ is applied, in a second stage a hydroxide or hydrated oxide of cerium, aluminum, or zirconium is applied, and in a third stage at least one hydroxide or hydrated oxide of cerium, aluminum, or zirconium and also an organic coupling agent are applied. In addition, the coupling agents must be hydrolyzed prior to binding to the pigment surface. According to the teaching of EP 0 888 410 B1, only a maximum of 60% of the added coupling agents can be bound to the pigment surface.

EP 0 888 410 B1 discloses modified pearlescent pigments based on a platelet-shaped substrate coated with metal oxides. According to the teaching of EP 0 888 410 B1 the top coat is composed of at least two oxides, oxide mixtures, or mixed oxides of silica, alumina, cerium oxide, titanium oxide, and zirconium oxide, and a water-based oligomeric silane system. No investigations are disclosed concerning the effect of the order of the oxidic protective layers in terms of their effectiveness on the UV stability of the pearlescent pigment. Consequently, no optimum protective-layer system is described. Furthermore, the water-based oligomeric silane system can only comprise hydrophobic fractions having not more than eight carbon atoms, since otherwise its water solubility is not assured. As a result, the possibility of variable aftercoating is limited in this case.

EP 0 649 886 provides pearlescent pigments coated with titanium dioxide or iron oxide, which are aftercoated in aqueous phase with a combination of hydrated cerium and aluminum oxides and subsequently dried.

According to the teaching of EP 1 203 795 a pearlescent pigment can comprise a layered system which, in a first layer, comprises hydrated oxides of silicon or aluminum and in a subsequent, second layer comprises hydrated oxides of silicon, aluminum, zirconium or cerium, the composition of the first layer being different from that of the second layer. The pearlescent pigment further comprises a third layer of at least one organic hydrophobic coupling agent, said organic hydrophobic coupling agent not being capable of reacting with the binder of, say, a coating system.

EP 1 084 198 B1 describes effect pigments, which, by virtue of their surface modification with reactive orientation agents, exhibit very strong adhesion to the basecoat. Viewed against this background EP 1 084 198 B1 does not disclose weather-stable pearlescent pigments.

In the case of the majority of the processes used in the prior art, SiO₂ and/or alumina is applied as the first layer. A cerium oxide layer is generally applied subsequently or is precipitated as a mixed oxide together with other components. The silanes are then usually attached in coprecipitation with the metal hydroxide in aqueous solution. In view of such coprecipitation of the hydroxides with the silane system, the efficiency of surface coverage with the oligomeric silane system is poor. Consequently, disproportionately large amounts of the expensive silanes are used, which unnecessarily increases the raw material costs.

When applying these coating techniques to platelet-shaped glass, it has not been possible to achieve any pigments having a weather stability capable of meeting the increasing market requirements.

WO 02/090448 discloses effect pigments based on glass flakes, which pigments comprise a highly refractive and calcined metal oxide layer as the topmost layer. These pigments are thus not suitable for use in pigmented coating materials intended for outdoor applications since they tend to show “chalking”—so-called “whitening” and loss of adhesion and luster under the influence of weather.

WO 2004/092284 relates to surface-modified effect pigments based on platelet-shaped substrates such as glass flakes, one or more calcined oxide layers being applied to the substrate either alone or in admixture with sulfates, phosphates, and/or borates, followed by the application of an organic top coat. The disadvantage of the pigments disclosed therein and comprising calcined oxide layers is that the silanes used as surface-coating agents display poor adhesion to annealed metal oxide layers.

These known pearlescent pigments do not have a weather stability capable of meeting the increasing market requirements.

It is an object of the present invention to provide weather-stable pearlescent pigments based on platelet-shaped glass and having a simple layered system providing effective protection against weathering and representing an improvement on the prior art. The layer system applied to the glass flakes, which are substantially less thick than conventional pearlescent pigments, is required, in particular, to afford effective protection against UV-induced photocatalytic activity of the pigment, without substantially impairing the optical properties such as luster. The pearlescent pigments of the invention are additionally provided with an organochemical surface coating which allows very good orientation behavior of the pearlescent pigments in the coating medium in conjunction with outstanding binding (very strong adhesion) to the binder. The pearlescent pigments of the invention are required to possess improved weather stability in general and can be used in automobile lacquers to particular advantage.

A further object is to provide a simple process for preparing weather-stable pearlescent pigments having a simple and effectively protective layered system. A further aim is to find a simple process for effectively applying the surface coating and showing great flexibility with regard to the aftercoating agents that can be used.

The object on which the invention is based is achieved by the provision of weather-stable pearlescent pigments based on a glass flake coated with highly refractive metal oxides and a protective top coat comprising a surface coating located on the topmost metal oxide layer. According to variant A, the weather-stable pearlescent pigment comprises a glass flake having an average thickness of from 50 nm to 500 nm, to which a metal oxide layer having a refractive index n greater than 1.8 is applied preferably so as to have an average thickness of from 30 nm to 300 nm, which metal oxide layer comprises TiO₂ having a rutile content ranging from 80 to 100% by weight and a protective top coat of SiO₂, preferably having an average thickness of from 1 nm to 50 nm, and an organochemical surface coating applied to the SiO₂ layer of the protective top coat.

According to a second variant B, the weather-stable pearlescent pigment comprises a glass flake having an average thickness of from 50 nm to 500 nm, to which a metal oxide layer having a refractive index n greater than 1.8 is applied preferably so as to have an average thickness of from 30 nm to 300 nm, which metal oxide layer comprises TiO₂ having a rutile content ranging from 80 to 100% by weight and a protective top coat comprising a first protective layer of cerium oxide and/or hydrated cerium oxide and/or cerium hydroxide and a second protective layer of SiO₂, and an organochemical surface coating applied to the SiO₂ layer of the protective top coat.

The 80 to 100 percentage by weight of TiO₂ always refers to the weight of the TiO₂ layer. Preferred developments of the subject matter of the invention are indicated in subclaims 2 to 26.

The subject matter of the invention is a weather-stable and UV-stable pearlescent pigment which displays reduced photocatalytic activity, increased light fastness, and optimized compatibility with commercially available pigmented coating systems.

The pearlescent pigment of the invention, which displays reduced photocatalytic activity, increased light fastness, and optimized compatibility with commercially available pigmented coating systems, is referred to hereinafter as “weather-stable”.

In the glass flake-based pearlescent pigments of the invention, the average thickness of the glass flake is less than 500 nm and more preferably ranges from 60 nm to 350 nm. Such thin glass flakes are suitable, in particular, for use in automobile lacquers, since in this case the basecoat layers have a very small thickness (12-15 μm) and the tendency is toward even smaller thicknesses. Due to the use of glass flakes of very small thickness as substrates, the overall thickness of the resulting pearlescent pigments is also within acceptable limits.

The small thickness of the glass flakes ensures an improved aspect ratio and thus an improved plane-parallel orientation of the resulting pearlescent pigments with respect to the substrate.

Unlike the mica used almost exclusively, glass flakes have substantially smooth surfaces. The layer thickness of an individual glass flake is more uniform across its length as compared with mica, since the latter, as a phyllosilicate, has a typical stepped structure. The non-uniform layer thickness of an individual flake caused by such steps brings about a reduction of the pearl luster effect (“graying”) following coating with highly refractive oxides.

Other transparent, synthetic substrates are known in the art which have similar advantages in terms of the properties mentioned above. These substrates are SiO₂ flakes and Al₂O₃ flakes. Pearlescent pigments based on these substrates are produced and sold under the names of Colorstream® and Xirallic® supplied by Merck. But glass flakes offer the advantage of simpler and more economical production than is the case with these substrates.

Furthermore, those glass flakes are preferred for use as substrates in which the standard deviation of thickness distribution is less than 20%, more preferably less than 15% and still more preferably less than 10%. These substrates make it possible to produce particularly color-intense pearlescent pigments having strong color flops.

The organochemical surface coating consists of one or more organofunctional silanes, aluminates, zirconates, and/or titanates.

The organochemical surface coating is preferably composed of silanes that are insoluble or poorly soluble in water but is preferably not in the form of a mixed layer with the SiO₂ coating. In other words, when the protective layer was produced, first SiO₂ and/or cerium oxide and/or hydrated cerium oxide and/or cerium hydroxide were applied to the effect pigment, after which the organochemical surface coating was applied.

The organochemical surface coating containing a silane mixture may be produced extremely advantageously in a simple way and can comprise a great diversity of surface modifiers.

It has been found, however, that a mixture of 3-aminopropyl-trimethoxysilane (DYNASYLAN® AMMO; produced by Degussa AG) and 3-glycidyloxypropyl-trimethoxysilane (DYNASYLAN® GLYMO; produced by Degussa AG) must be avoided, since in this case the pigments tend to agglomerate. This tendency is presumably attributable to the interparticulate reaction of the outer amino groups with the epoxy groups, which causes “caking” of the pigments.

In view of the multiplicity of usable surface modifiers that can be used, the pigment of the invention can be made compatible with all standard pigmented coating systems. The optical properties such as luster are very good.

In one development of the invention, the pigment may comprise another protective coating of metal oxides other than cerium oxide and/or hydrated cerium oxide and/or cerium oxide and SiO₂, preferably ZrO₂.

The process of the invention for providing the pearlescent pigment of the invention comprises the following steps:
(a) suspending a metal oxide-coated glass flake in a liquid phase, the metal oxide having a refractive index greater than 1.8,
(b1) applying an SiO₂ protective top coat to the glass flake suspended in step (a) or
(b2) applying a protective top coat comprising a first protective layer of cerium oxide and/or hydrated cerium oxide and/or cerium hydroxide and a second protective layer of SiO₂ to the glass flake suspended in step (a),
(c) applying an organochemical surface coating to the topmost structural layer of SiO₂ produced in step (b1) or (b2).

Preferred developments of the process of the invention are defined in claims 28 to 35.

Preferably step (c) is carried out using one or more organofunctional silanes in a liquid phase containing a predominant fraction of organic solvent. It is extremely advantageous in this context that numerous additives, particularly hydrophobic silanes, show very good solubility in predominantly organic solvents. This makes for simple process management and great flexibility in the choice of surface coating agents.

By a “predominantly organic solvent mixture” is meant a mixture containing preferably less than 50% by weight of water.

The non-organic fraction of solvent in these cases is preferably water.

It has now been found surprisingly, that excellent UV and weather stabilities are achieved in pearlescent pigments by using a pearlescent pigment based on a metal oxide-coated glass flake having an average thickness of from 50 nm to 500 nm, preferably having an average thickness of from 60 nm to 350 nm and very preferably having an average thickness of from 70 nm to 300 nm.

In variant A of the pearlescent pigment of the invention, a protective top coat comprising or composed of SiO₂ followed by an organochemical aftercoat is applied directly to the metal oxide-coated thin glass flake.

In variant B of the pearlescent pigment of the invention, a protective top coat comprising a first protective layer of cerium oxide and/or hydrated cerium oxide and/or cerium hydroxide and a second protective layer of SiO₂ followed by an organochemical aftercoat is applied directly to the metal-oxide coated thin glass flake.

Both of the pearlescent pigments of the invention comprising glass flakes of small thickness and showing a defined thickness tolerance and provided with a surface-modified protective coating can be used to advantage in all applications known to the person skilled in the art, particularly in automobile lacquers incorporating basecoat layers of very small thickness (12 μm to 15 μm). In particular, the variant B pearlescent pigment of the invention comprising a surface-modified protective layer system of cerium oxide and/or hydrated cerium oxide and/or cerium hydroxide and SiO₂ affords very good UV protection.

Despite the low refractive index of SiO₂, which is the topmost metal oxide layer in both variants, the pigments surprisingly exhibit very good luster.

This was by no means to have been expected, particularly since it is stated in DE 42077237 A1, p. 2, lines 19 to 21, that: “Pigments coated with silicate or with Al₂O₃ are difficult to disperse and additionally show luster reductions in printing inks and coats of paint.”

It has further been found, surprisingly, that even thin layer thicknesses of the protective layers are adequate for high UV stability.

The cerium-containing protective layer additionally present in variant B pigments of the invention is or comprises cerium oxide and/or cerium hydroxide and/or hydrated cerium oxide. The cerium-containing layer is applied by the precipitation of cerium hydroxide and is partly or completely converted by dehydration, for example with heating, to cerium oxide and/or hydrated cerium oxide. The protective layer may therefore also contain cerium hydroxide and/or hydrated cerium oxide in addition to cerium oxide, even though reference is made below to a cerium oxide layer.

The cerium used is in trivalent or tetravalent form or mixtures of these two forms are used. The cerium is preferably used in trivalent form.

The amount of cerium used, preferably in the form of cerium oxide and/or hydrated cerium oxide and/or cerium hydroxide, is preferably from 0.05% to 3.0%, more preferably from 0.1% to 1.0% and very preferably from 0.2% to 0.7%, by weight, based in each case on the total weight of the pigment. The weight of cerium used should preferably not be above 1.0% by weight of the weight of pigment used, since otherwise losses in the optical quality of the pigment might be too great. On the other hand, below 0.1%, the additional UV stabilization is generally not sufficiently pronounced.

In any specific case, the weight of cerium oxide and/or hydrated cerium oxide and/or cerium hydroxide will depend on the fineness and, concomitantly, on the specific surface area of the pearlescent pigment and on the thickness of the TiO₂ layer. Finer pigments and thicker TiO₂ layers generally also necessitate a higher content of cerium oxide and/or cerium hydroxide and/or hydrated cerium oxide.

The SiO₂ protective layer present in both variants of the pearlescent pigments of the invention has an average thickness from 1 nm to 50 nm, preferably from 2 nm to 20 nm, and more preferably from 2.5 nm to 7 nm.

The SiO₂ content of the variant A pearlescent pigments of the invention is preferably equal to from 0.5% to 10% by weight, more preferably from 1.0% to 7%, even more preferably from 1.5% to 7% by weight, still more preferably from 1.6% to 6% by weight and most preferably from 2% to 5% by weight, based in each case on the total weight of the pigment.

The SiO₂ content of the variant B pearlescent pigments of the invention is preferably equal to from 0.5% to 8% by weight, more preferably from 1.0% to 6.5%, even more preferably from 1.5% to 5% by weight and most preferably from 1.8% to 4.5% by weight, based in each case on the total weight of the pigment.

Here again, in any specific case, the amount of SiO₂ will depend on the average thickness of the glass flake, the fineness and, concomitantly, on the specific surface area of the pearlescent pigment and on the thickness of the TiO₂ layer. Pigments having thinner glass flakes, or finer pigments and thicker TiO₂ layers generally have a higher content of SiO₂. Above 10% by weight of SiO₂, no further improvement of any kind is observed in the weather stability or UV stability. Often the properties will even become poorer, probably because the thicker protective layers are brittle and/or friable and cracks form more easily, as a result of which the photoactivity of the coated TiO₂ is no longer sufficiently suppressed. Below 0.5% by weight, the protective effect of the SiO₂ layer is too low.

The SiO₂ protective top coat may also contain hydroxides and/or hydrated oxides of silicon in addition to SiO₂.

In the case of variant A of the pearlescent pigment of the invention, the surprisingly high effectiveness of a coating composed solely of silicate in making the pearlescent pigments weather-stable is presumably attributable, inter alia, to the electronic nature of the SiO₂ layer. It is thought that the energetic level of the edges of the band of SiO₂ in comparison with that of TiO₂ in the TiO₂-coated pearlescent pigment used preferably is of a favorable nature such that the transfer of both electron holes and electrons, which arise in the TiO₂ semi-conductor following absorption of UV photons, at the pigment interface is effectively suppressed (“diode effect”). This appears to be plausible, since the effective weather stability of pearlescent pigments can already be observed in extremely thin SiO₂ layers of approx. only 2 to 3 nm. Apart from the electronic effect, a certain barrier effect is also thought to be significant for weather stability. Inter alia, the barrier effect keeps water away from the TiO₂ interface. But this effect is presumably not a decisive factor due to the small layer thickness. The thickness of the SiO₂ layers preferably ranges from 2 nm to 20 nm and more preferably from 2.5 nm to 7 nm.

It is thought that the improved weather and UV stabilities of the pigment type B of the invention are particularly attributable, apart from the aforementioned effect of the SiO₂ layer, to the order of the layers used in the invention, i.e. the initial application of cerium oxide followed by SiO₂. Cerium oxide and/or hydrated cerium oxide and/or cerium hydroxide are known per se to be very effective agents for suppressing the photochemical activity of TiO₂.

The activity probably derives in particular from the well known Ce(III)/Ce(IV) redox system. By means of this system, free radicals, which are generated on the surface of the TiO₂ as a result of its photochemical activity, can react effectively. Apparently this efficiency of cerium oxides as a barrier for photocatalytically produced free radicals is particularly effective when cerium oxide and/or hydrated cerium oxide and/or cerium hydroxide is deposited as the very first layer in direct contact with the TiO₂ surface of the starting pigment.

In the case of the B variant of the pigment of the invention, it is preferred to apply the cerium oxide and/or hydrated cerium oxide and/or cerium hydroxide layer directly to the TiO₂ layer.

The cerium oxide and/or hydrated cerium oxide and/or cerium hydroxide layer, however, need not necessarily be applied directly to the TiO₂ layer. The cerium oxide and/or hydrated cerium oxide and/or cerium hydroxide layer is preferably applied by separate precipitation, i.e., not as a coprecipitation, so that the cerium oxide and/or hydrated cerium oxide and/or cerium hydroxide layer is preferably substantially free of other metal oxides.

The cerium-containing layer of cerium oxide and/or hydrated cerium oxide and/or cerium hydroxide is preferably a discrete layer which does not form a mixed layer with the underlying layer, for example, a metal oxide layer such as a titanium oxide layer.

In the case of the pigment type B, it is preferred, moreover, to apply the SiO₂ layer directly to the cerium oxide and/or hydrated cerium oxide and/or cerium hydroxide layer. Very preferably, the SiO₂ layer is applied from a predominantly organic solvent mixture using sol-gel methods, as explained below. It is further preferred that the SiO₂ layer likewise be a discrete layer which does not form a mixed layer with the cerium-containing layer of cerium oxide and/or hydrated cerium oxide and/or cerium hydroxide.

The variant B pigments of the invention therefore preferably have a protective layer system comprising a cerium oxide and/or hydrated cerium oxide and/or cerium hydroxide layer, directly followed by an SiO₂ layer, to which the specified surface coating containing at least one silane having at least one functional binding group and at least one silane not having a binding group is applied. This protective layer system is preferably applied directly to a TiO₂ layer.

In the case of the pearlescent pigment type B, the SiO₂ protective layer, i.e., the second protective layer applied to the cerium oxide and/or hydrated cerium oxide and/or cerium hydroxide in each case constitutes a further barrier. It protects the surface of the pearlescent pigment from water infiltration and, conversely, bars any free-radical species that might possibly have passed through the cerium oxide and/or hydrated cerium oxide and/or cerium hydroxide layer.

Advantageous properties of the pearlescent pigments of the invention have been achieved not only on the basis of the optimized oxide layer architecture described above.

Surprisingly, further advantageous application properties have been obtained by means of an organochemical silane aftercoat on the SiO₂ layer. Surprisingly, the pearlescent pigment of the invention exhibits outstanding orientation behavior in the coating medium. The optical properties such as luster are very good.

By a functional binding group is meant a functional group which is able to interact chemically with the binder. This chemical interaction may be in the form of a covalent bond, a hydrogen bond or an ionic interaction.

The functional binding groups comprise acrylate groups, methacrylate groups, vinyl groups, amino groups, cyanate groups, isocyanate groups, epoxy groups, hydroxyl groups, thiol groups, ureido groups and/or carboxyl groups.

The choice of a suitable functional group depends on the chemical nature of the binder. Preferably, a functional group which is chemically compatible with the functionalities of the binder is selected to allow for efficient binding attachment. This property is very important with respect to the weather stability and UV stability of pearlescent pigments, since in this way sufficiently strong adhesion is achieved between the pigment and the cured binder. This can be tested for in, say, adhesion tests such as the cross-cut test under condensation test stress as specified in DIN 50 017. Passing such a test is a prerequisite for the use of weather-stable pearlescent pigments in an automobile lacquer.

The organofunctional silanes advantageously used as organochemical surface coating agents have a pronounced tendency to condensation by nature and thus the ability to bind to a SiO₂ surface. The SiO₂ surface is terminated with silanol groups (Si—O—H), which, by virtue of their chemical similarity to organofunctional silanes, offer the best binding possibilities for these surface-coating agents.

The organofunctional silanes are available commercially and are produced, for example, by Degussa, Rheinfelden, Germany and sold under the trade name “Dynasylan”. Further products can be purchased from OSi Specialties (Silquest® silanes) or from Wacker (in particular, the standard and α-silanes from the GENIOSIL® group of products).

Preferred examples of silanes that can be used are 3-methacryloxypropyl-trimethoxysilane (Dynasylan MEMO, Silquest A-T 74NT), vinyltri(m)ethoxysilane (Dynasylan VTMO or VTEO, Silquest A-151 or A-171), 3-mercaptopropyl-tri(m)ethoxysilane (Dynasylan MTMO or 3201; Silquest A-189), 3-glycidoxypropyl-trimethoxysilane (Dynasylan GLYMO, Silquest A-187), tris(3-trimethoxysilylpropylisocyanurate) (Silquest Y-11597), gamma-mercaptopropyl-trimethoxysilane (Silquest A-189), bis(3-triethoxysilylpropylpolysulfide) (Silquest A-1289), bis(3-triethoxysilyldisulfide) (Silquest A-1589), beta-(3,4-epoxycyclohexyl)ethyl-trimethoxysilane (Silquest A-186), bis(triethoxysilyl)ethane (Silquest Y-9805), gamma-isocyanatopropyl-trimethoxysilane (Silquest A-Link 35, GENIOSIL GF40), (methacryloyloxymethyl)tri(m)ethoxysilane (GENIOSIL XL 33, XL 36), (methacryloxymethyl)(m)ethyldimethoxysilane (GENIOSIL XL 32, XL 34), (isocyanatomethyl)trimethoxysilane (GENIOSIL XL 43), (isocyanatomethyl)methyldimethoxysilane (GENIOSIL XL 42), (isocyanatomethyl)trimethoxysilane (GENIOSIL XL 43) 3-(triethoxysilylpropyl) succinic anhydride (GENIOSIL GF 20).

In one preferred embodiment, the organofunctional silane mixture that modifies the SiO₂ layer comprises, in addition to at least one silane not having a functional binding group, at least one amino-functional silane. The amino function is a functional group which is able to interact with the majority of groups present in binders. This interaction may be in the form of a covalent bond, such as with isocyanate or carboxylate functions of the binder, for example, or hydrogen bonds such as with OH or COOR functions, or else ionic interactions. The amino function is therefore very highly suitable for the purpose of chemically binding the effect pigment to different kinds of binder.

The following compounds are preferably employed for this purpose:

aminopropyl-trimethoxysilane (Dynasylan AMMO; Silquest A-1110), aminopropyl-triethoxysilane (Dynasylan AMEO) or N-(2-aminoethyl)-3-aminopropyl-trimethoxysilane (Dynasylan DAMO, Silquest A-1120) or N-(2-aminoethyl)-3-aminopropyl-triethoxysilane, triamino-functional trimethoxysilane (Silquest A-1130), bis(gamma-trimethoxysilylpropyl)amine (Silquest A-1170), N-ethyl-gamma-aminoisobutyl-trimethoxysilane (Silquest A-Link 15), N-phenyl-gamma-aminopropyl-trimethoxysilane (Silquest Y-9669), 4-amino-3,3-dimethyl-butyl-trimethoxysilane (Silquest Y-11637), N-cyclohexylaminomethylmethyl-diethoxysilane (GENIOSIL XL 924), (N-cyclohexylaminomethyl)-triethoxysilane (GENIOSIL XL 926), (N-phenylaminomethyl)-trimethoxysilane (GENIOSIL XL 973), and mixtures thereof.

In one further preferred embodiment, the silane not having a functional binding group is an alkylsilane. The alkylsilane preferably has the formula (I):

R_{(4-z)}Si(X)_{z}, (I)

In this formula, z is an integer from 1 to 3, R is a substituted or unsubstituted, unbranched or branched alkyl chain having from 10 to 22 carbon atoms, and X is a halogen and/or alkoxy group. Preference is given to alkylsilanes having alkyl chains containing at least 12 carbon atoms. R may also be joined cyclically to Si, in which case z is usually 2.

A silane of this kind produces strong hydrophobization of the pigment surface. This in turn leads to a tendency of the pearlescent pigment thus coated to rise to the top of the pigmented coating. In the case of platelet-shaped effect pigments, a behavior of this kind is referred to as “leafing”.

It has now been found, very surprisingly, that a silane mixture composed of at least one silane possessing at least one functional group which allows for attachment to the binder and a sparingly water-soluble or water-insoluble alkylsilane not having an amino group as described above provides optimum application properties on the part of the pearlescent pigments.

The pearlescent pigments are bound so effectively to the coating material that there is no loss of adhesive strength. On the other hand, the pigments exhibit an outstanding plane-parallel orientation in the paint, and also a “residual leafing” behavior; in other words, a statistically measurable fraction of the pigments is located in the upper region of the cured basecoat in the vicinity of the clear coating. Normally, the presence of pigments at the upper interface of the basecoat leads to a loss of adhesion properties, since, because of its platelet-shaped architecture, the pearlescent pigment acts as an interference barrier between clearcoat and basecoat. In the case of the present invention, surprisingly, the pigments assemble not at the upper interface of the basecoat but only in the vicinity of the upper interface of the basecoat, thereby allowing reliable attachment of the clearcoat to the basecoat. In other words the pigments of the invention act advantageously as an interference barrier between clearcoat and basecoat.

This “residual leafing” behavior and the very good plane-parallel orientation produce improved luster properties and a high color purity of the pearlescent pigments of the invention in, for example, a coating system.

At an alkylsilane chain length of less than 10 carbon atoms, the hydrophobization of the surface is not sufficient to exhibit such effects. In this case, it is thought that it is not possible for any segments to be developed on the pigment surface in which the alkyl chains are aligned parallel to one another in the manner of a “self-assembly monolayer”. Layers of this kind are preferentially obtained if a surface is coated with additives which have an anchor group to the surface and alkyl chains having at least 10 carbon atoms.

Where the silanes possess more than 22 carbon atoms, the attachment to the binder system via the silane having functional binding groups is generally no longer good enough; in other words, adhesion problems are observed in the condensation test specified in DIN 50 017. In a further preferred embodiment, the surface modification comprises silanes of the structural formula (II)

(R¹—X-[A-Y]ₙ—B)_{(4-z)}Si(OR²)_{z} (II)

in which
n denotes 1 to 100.
z is an integer from 1 to 3,
R¹ is a linear or branched alkyl group having from 1 to 12 carbon atoms which may be substituted by halogens; an aryl group having 6 to 12 carbon atoms; or an aryl group having from 6 to 12 carbon atoms which may be substituted by alkyl having from 1 to 6 carbon atoms and/or by halogens;
R² is a linear or branched alkyl group having from 1 to 6 carbon atoms;
A and B independently stand for a divalent group consisting of a linear or branched alkylene group having from 1 to 12 carbon atoms; an arylene group having from 6 to 12 carbon atoms; or an arylene group having from 6 to 12 carbon atoms which may be substituted by alkyl having from 1 to 6 carbon atoms and/or by halogens; and
X and Y are independently O or S.

By halogen is meant F, Cl, Br and/or I.

In preferred embodiments, R¹ und R² are independently methyl, ethyl, n-propyl, isopropyl, n-butyl, isobutyl, tert-butyl, phenyl, biphenyl, naphthyl, or mixtures thereof.

In further preferred embodiments, A and B independently denote ethylene, propylene, 1-butylene, 2-butylene, phenylene, phenylene substituted by alkyl having from 1 to 6 carbon atoms, and mixtures thereof.

These silanes may be in pure form with a defined value of n or in mixtures with different values of n.

According to one preferred embodiment, n ranges from 1 to 20, more preferably from 5 to 15.

In one particularly preferred embodiment, the surface coating comprises silanes of formula (III)

H₃CO—[CH₂—CH₂—O—]ₙCH₂—CH₂—Si(OR²)₃, (III)

in which n=1 to 100, preferably 1 to 20, more preferably 5 to 25, and R² has the meanings stated above. Most preferably, R² is independently methyl or ethyl.

These silanes too may be present in pure form with a defined value of n or in mixtures (different values of n). By virtue of their oxyethylene group(s) within the chain, silanes of this kind have particularly good wetting and dispersing properties. Such silanes are available from OSi Specialties under the product name Silquest® A-1230.

Prior to application to the SiO₂ layer, the organofunctional silanes are preferably in predominantly monomeric form.

The amount of the surface coating agents applied in monomeric, oligomeric, or polymeric form as an aftercoat, based on the total pearlescent pigment coated with cerium oxide and SiO₂, is preferably from 0.1% to 6%, more preferably from 0.2% to 5%, very preferably from 0.3% to 3% and most preferably from 0.5 to 2.5% by weight.

In specific cases, it is also possible for the amount to depend on the fineness and specific surface area of the pearlescent pigment. Generally speaking, however, an amount in the order of magnitude of one or less silane monolayer(s) on the pigment surface is sufficient. Excessively small amounts lead to inadequate coating of the pigment surface and, consequently, to poor condensation test results in coating applications (test specified in DIN 50 017).

The mixing ratio, by weight, of the silanes containing at least one functional binding group to the silanes not containing a functional binding group is preferably from 1:5 to 5:1, more preferably from 1:3 to 3:1, and very preferably from 1:2 to 2:1, these percentages by weight referring to the silanes in their form as starting compounds.

If the silane mixture as a whole contains too few functional binding groups, the surface coating becomes too hydrophobic. This can lead to adhesion problems in the coating applications in the course of a stress test such as the condensation test specified in DIN 50 017. In the case of an excess of functional binding groups, on the other hand, the surface will be too hydrophilic and the ability of the pigment to form a paste in a water-based paint, and also the orientation of the pearlescent pigments in the cured applied coating, will be poorer. In the condensation test, a pronounced hydrophilicity of the pigment promotes the storage of water in the layer of coating material, which can primarily result in a reduced distinctness of image (DOI) and the formation of microfine water bubbles.

In another embodiment of the invention, the pearlescent pigment to be stabilized is coated with a mixed layer of cerium oxide and/or hydrated cerium oxide and/or cerium hydroxide and SiO₂ as the first protective layer. The cerium employed is in trivalent or tetravalent form or a mixture of these two forms, but preferably in trivalent form. Preference, however, is given to a layer sequence of, firstly, cerium oxide and/or hydrated cerium oxide and/or cerium hydroxide and, secondly, SiO₂, since this provides higher UV stability. In a further embodiment of the invention, the glass flake has one or more metal oxide layers, preferably a layer of tin oxide. The layer of tin oxide can be applied as described, for example, in Examples 1 and 5 of DE 3535818 A1 incorporated herein by reference. This layer is preferably applied during the actual operation of producing the substrate, and is subsequently calcined. Tin oxide is used in the preparation of pearlescent pigments in order to induce a rutile system in a TiO₂ layer precipitated onto the substrate, preferably mica flakes. TiO₂ grows on mica in an anatase system, which, because of its higher photoactivity, is unwanted. Coating the substrate with SnO₂, however, induces a rutile modification of the subsequent TiO₂ layer, since the two oxides have a similar crystalline structure.

It has now been found, surprisingly, that an additional coat of SnO₂ following a TiO₂ coat, i.e., applied prior to application of the first protective layer composed of or comprising cerium oxide and/or hydrated cerium oxide and/or cerium hydroxide and the second protective layer of SiO₂, further increases the weather stability. The SnO₂ layer is preferably applied directly to the TiO₂ layer.

In a further embodiment of the invention, it is possible for the pigment to contain another metal oxide layer, in addition to the first protective layer composed of or comprising SiO₂ and/or cerium oxide and/or hydrated cerium oxide and/or cerium hydroxide. These metal oxides are preferably ZrO₂.

According to the invention, other layers, preferably those having a high refractive index (n greater than 1.8) can be deposited on the glass flakes coated with a metal oxide having a poor refractive index (n lower than 1.8) such as SiO₂. Such layers are preferably selected from the group consisting of metal chalcogenides, in particular metal oxides, metal hydroxides, hydrated metal oxides, metal suboxides, and metal sulfides, metal fluorides, metal nitrides, metal carbides, and mixtures thereof.

The glass substrates of the pearlescent pigments are preferably coated with a multilayer system comprising or composed of metal oxide, metal hydroxide, metal suboxide, and/or hydrated metal oxide, the order of the layers being variable. The metal oxides, metal hydroxides, metal suboxides and/or hydrated metal oxides can also be present side-by-side in the same layer.

The substrates of the pearlescent pigments are preferably coated with one or more metal oxide layers from the group consisting of or comprising TiO₂, Fe₂O₃, Fe₃O₄, TiFe₂O₅, ZnO, SnO₂, CoO, CO₃O₄, ZrO₂, Cr₂O₃ VO₂, V₂O₃, (Sn,Sb)O₂ and mixtures thereof. TiO₂ and/or Fe₂O₃ are particularly preferred.

In another embodiment, the multilayer system has a layer sequence in which at least one highly refractive layer and at least one poorly refractive layer are disposed alternately on a substrate.

In the alternating arrangement of layers, it is also possible for one or more highly refractive layers to be disposed directly on top of each other followed by one or more poorly refractive layers disposed directly on top of each other. However, it is essential that the layer system be composed of both highly and poorly refractive layers.

The multilayer system preferably has a layer sequence in which at least one highly refractive layer, at least one poorly refractive layer, and at least one highly refractive layer are disposed successively on a substrate.

In this variant also, one or more poorly or highly refractive layers may be disposed directly on top of each other. It is essential, however, that the layer system, regarded from the inside toward the outside, be composed of highly refractive and poorly refractive layers and again highly refractive layers.

The at least one highly refractive layer preferably contains or comprises metal oxide and/or metal hydroxide from the group consisting of TiO₂, Fe₂O₃, Fe₃O₄, TiFe₂O₅, ZnO, SnO₂, CoO, CO₃O₄, ZrO₂, Cr₂O₃ VO₂, V₂O₃, (Sn, Sb)O₂, and mixtures thereof. Preferably, the poorly refractive layer contains or preferably comprises metal oxide and/or metal hydroxide from the group consisting of SiO₂, Al₂O₃, and mixtures thereof.

Pearlescent pigments comprising highly and poorly refractive layers yield particularly intense interference colors. Pearlescent pigments having a highly refractive and poorly refractive and again a highly refractive layer are particularly preferred. A layer sequence comprising or composed of TiO₂/SiO₂/TiO₂ and optionally another layer containing Fe₂O₃ can produce intense gold hues and is therefore particularly preferred.

In another embodiment, the glass flakes of pearlescent pigments used as substrate are coated on both sides with semi-transparent metal layers.

The metals of the semi-transparent metal layers are preferably selected from the group consisting of silver, aluminum, chromium, nickel, gold, platinum, palladium, copper, zinc, and mixtures and alloys thereof. The thickness of the semitransparent layers preferably ranges from approx. 2 nm to approx. 30 nm and more preferably from approx. 5 nm to approx. 20 nm.

In order to produce a good pearl luster effect, the refractive index of the metal oxide layer is greater than 1.8, preferably greater than 2.2, more preferably greater than 2.3, still more preferably greater than 2.4 and very preferably 2.5 or more.

Glass flakes coated with TiO₂ and/or iron oxide are supplied, for example, by Engelhard, USA under the names of Firemist® and Reflecks® or by Merck, Germany under the names of Miraval® and Ronastar®.

Additionally, multilayer interference pigments, as described, for example, in DE 19618569 and composed of a carrier coated with alternating layers of metal oxides of low and high refractive index, can be aftercoated as specified in the present invention.

In a preferred variant B, the aforementioned pigments can be stabilized to outstanding effect against UV-induced photocatalytic activity with a first protective layer consisting of or comprising cerium oxide and/or hydrated cerium oxide and/or cerium hydroxide and then with a second protective layer of SiO₂, followed by an organochemical aftercoat.

In the process of the invention, after step (c), the pigment can be separated from the solvent and optionally dried. It is also possible, if necessary, for size classification operations to follow.

The cerium hydroxide layer is precipitated preferably with the optional addition of water and optional addition of base or acid at reaction temperatures ranging from room temperature to the boiling temperature of the solvent and optionally in the presence of a catalyst. The acidic or basic components released during the deposition reaction, such as protons or hydroxyl ions can be neutralized or partially neutralized by adding a base or an acid before starting with the deposition of silicate, preferably SiO₂. The base or acid can be metered in conjunction with the cerium reagent or after the introduction of the cerium salt solution.

It has been found, surprisingly, that the precipitation of the cerium reagents used takes place almost completely, preferably completely, at pH's ranging from 3 to 8, preferably from 4 to 7, so that an almost pure, preferably pure, SiO₂-layer is applied as caused by the subsequent addition of preferably tetraalkoxysilane with precipitation of SiO₂.

According to the invention, the cerium-containing layer and the SiO₂ layer are applied sequentially, so that preferably separate, discrete layers are applied.

The uncalcined SiO₂ layer is preferably applied by a sol-gel process in the predominantly organic solvent mixture. In this case, in step (b), the SiO₂ layer is applied using, preferably, tetraalkoxysilane, with the optional addition of water. Sol-gel methods of this kind carried out in a predominantly organic solvent mixture have advantages over the deposition of SiO₂ from aqueous silicate solutions, as described in the prior art.

Modern binder systems are very sensitive to the presence of salts. These salts, for example, disrupt the colloidal stability of binder particles and may therefore induce uncontrolled coagulation of the binder system of a coating material. As a result, the coating material will become unusable. Moreover, water-soluble constituents such as salts promote osmotic processes in pigmented coating systems, and so, as a result of the accumulation of water in the coated film, there may be bubbling and problems associated with the loss of adhesion. A salt-free or low-salt production process for a pearlescent pigment renders costly and laborious purification steps unnecessary. In other words, the pigments of the invention show, following slurrying, lower conductivities than usual.

The by-products of the reaction are predominantly alcohols, which can be worked up together with the alcoholic solvent, for example, by distillation, and then recycled.

Si(OR)₄+2H₂O SiO₂+4ROH

According to a preferred development of the invention, the alkoxy group of the tetraalkoxysilane is the same as in the organic solvent used. During hydrolysis of the tetraalkoxysilane there is a release of the corresponding alcohol, for example, methanol, ethanol or propanol, when R denotes CH₃, C₂H₅ or C₃H₇. When methanol, ethanol, or propanol are used as organic solvents, no mixture of different solvents is obtained following hydrolysis, which is a very great advantage with regard to working up and recycling the solvent.

Another advantage is gained by using a monomeric starting material for the production of the SiO₂ layer. In the case of the sol-gel process carried out in organic solvent, the reaction commences with the hydrolysis of the tetraalkoxysilane, i.e., a molecular monomer. Aqueous silicate solutions such as water glass are by contrast always in an oligomeric form of precondensed O—Si—O units. Therefore, in the case of the sol-gel process as preferably used in the present invention, the hydrolysis step and also the subsequent condensation reaction can be controlled more effectively. This is advantageous as regards the quality and morphology of the layer formed. The controlled deposition of the SiO₂ in the sol-gel process in a predominantly organic solvent mixture is also thought to be responsible for the high quality of the layer and the very good barrier effect resulting therefrom.

As starting compounds for the SiO₂ layer, it is preferred to use tetraalkoxysilanes. Examples thereof include the following: tetramethoxysilane, tetraethoxysilane, tetrapropoxysilane, tetraisopropoxysilane and tetrabutoxysilane, or mixtures thereof.

Catalysis in the sol-gel process for SiO₂ deposition preferably proceeds in a basic medium. The catalysts used are preferably nitrogen-containing bases. Examples thereof include ammonia, hydrazine, methylamine, ethylamine, triethanolamine, dimethylamine, diethylamine, methylethylamine, trimethylamine, triethylamine, ethylenediamine, trimethylenediamine, tetramethylenediamine, 1-propylamine, 2-propylamine, 1-butylamine, 2-butylamine, 1-propylmethylamine, 2-propylmethylamine, 1-butylmethylamine, 2-butylmethylamine, 1-propylethylamine, 2-propylethylamine, 1-butylethylamine, 2-butylethylamine, piperazine, and pyridine.

These bases are also suitable for neutralization of the protons which may be released during the deposition of cerium hydroxide.

For example, HNO₃ or HCl are suitable for neutralization of basic components which may be released during the deposition of cerium hydroxide.

In one preferred variant of the process of the invention, the liquid phase in step (a) is a predominantly organic solvent mixture.

More preferably, the entire coating operation (b1) or (b2) and (c) for the pearlescent pigment is carried out in a predominantly organic solvent mixture or in a liquid phase having a predominant fraction of organic solvent or in a liquid phase having a predominant fraction of organic solvent. “A predominantly organic solvent mixture” here means one containing preferably less than 50% by weight of water.

Examples of organic solvents used include ethers, esters, alcohols, ketones, aldehydes, and white spirit.

The predominantly organic solvent mixtures used are preferably alcoholic solvents having an alcohol content of from 50% to 99% by weight. The alcohol fraction is preferably from 60% to 95% and more preferably from 70% to 90%, by weight. Below an alcohol fraction of 50% by weight, the application properties of the coated pearlescent pigments may be impaired. This can result in loss of luster of a coating, for example. Above 99% by weight, finally, the reaction mixture apparently contains too little water, which leads to delayed hydrolysis of the alkoxy silanes, as a result of which the reaction times are excessively long.

Suitable alcohols include, for example, methanol, ethanol, n-propanol, isopropanol, n-butanol, 2-methylpropanol, 2-methoxypropanol, butyl glycol, etc. Mixtures of these alcohols are also possible in any desired proportions.

The residual content of the mixture comprises the reactant water plus organic solvents.

The advantage associated with the use of predominantly organic solvents, particularly in step (c), lies in the very good solubility of many silanes in organic solvents. As a result, it is possible to use not only hydrophilic silanes but also, in particular, hydrophobic silanes for the surface coating. In aqueous solutions, by contrast, many silanes are not soluble, in which case the remedy employed is that of controlled prehydrolysis of the silanes [U.S. Pat. No. 5,759,255] or the synthesis of specific water-soluble oligomer systems [DE 196 39 783]. Prehydrolyzed silane systems, however, are not very storable. Further hydrolysis or condensation processes may cause the silanes to undergo further crosslinking and oligomerization, and they may finally become useless for the purpose of surface coating. Finally, water-soluble oligomer systems must first be synthesized, which increases costs. They are likewise relatively difficult to store, and are restricted as to the diversity of possible variations of the organofunctional groups. Alkylsilanes having from 10 to 22 carbon atoms, in particular, are insoluble or only sparingly soluble in water. By contrast, apolar alkylsilanes of this kind can be readily dissolved in the solvents used here, which is beneficial to the formation of layers on the pigment surface. In addition, it is possible to use the relatively expensive silanes with economic efficiency.

Aminosilanes, on the other hand, are generally soluble in water, but they undergo autocatalytic hydrolysis and condensation to form oligomeric and polymeric systems. Their storage stability in water is therefore restricted.

As a result of the greater number of silanes available as surface-coating agents, the surface properties of the pearlescent pigments of the invention can be variously adapted to different coating systems. By contrast, when using prehydrolyzed silanes and particularly water-soluble silane oligomers, the formulator is restricted to the use of short-chain aliphatic or aromatic radicals having not more than 8 carbon atoms.

Steps (a) to (c) of the process described are preferably carried out in the same liquid medium. In this embodiment, cerium salts sufficiently soluble in the predominantly organic solvent are used for step (b). Preferred examples for this purpose are cerium(III) acetate, cerium(III) octoate, cerium(III) acetylacetonate, cerium(III) nitrate, cerium(III) chloride, and cerium(IV) ammonium nitrate.

In one preferred process, step (c) for modifying the SiO₂ and/or cerium oxide and/or hydrated cerium oxide and/or cerium hydroxide layer is carried out in a liquid phase having a predominant fraction of organic solvent. By, the term “a predominant fraction of organic solvent” is meant a solvent mixture containing preferably less than 50% by weight of water, i.e., more than 50% by weight of organic solvent.

Examples of organic solvents used include ethers, esters, alcohols, ketones, aldehydes, and white spirit.

The preferred variant of the process of the invention, as described here, is distinguished by a one-pot process in which the organochemical aftercoating takes place immediately following coating with cerium oxide/hydroxide and subsequently with SiO₂. The silanes are added directly, i.e., without prehydrolysis, to the reaction solution, undergo hydrolysis in situ, and finally condense with hydroxyl groups of the SiO₂ layer, so that covalent bonding to the pigment surface takes place. This results in extremely simple process management in conjunction with a very good choice of usable silanes.

It is particularly advantageous to use silanes which contain at least one functional binding group and have not undergone prehydrolysis to an extent of more than 50% and have preferably not been prehydrolized.

In another variant of the process of the invention, the SiO₂ coating operation can also be effected using silicate solutions in an aqueous medium following the application of the cerium oxide and/or hydrated cerium oxide and/or cerium hydroxide coating from aqueous solution. The conditions for depositing cerium or silicate compounds from aqueous solution are described, for example, in Example 2, lines 30 to 37 of EP 0 141 174 or in Example 1 of EP 649 886 B1 and also in Example 1 of DE 4 207 723 or in Example 1 of DE 2 106 613, which are incorporated herein by reference. Subsequently, a calcining step can be carried out, if appropriate. The conditions necessary for such a step are known per se to the person skilled in the art and can be found in, say, DE 2 106 613 or DE 3 535 818.

The coated pearlescent pigments of the invention are used, in particular, as weather-stable pearlescent pigments in paints, e.g. automobile lacquers and also in powder coatings, printing inks, plastics, cosmetic preparations, and coatings for weather-stable exterior applications and architectural facing applications.

To great advantage, the pearlescent pigments of the invention allow for the provision of single-coat UV-stable and weather-stable paint or pigmented coating systems, to which no subsequent clearcoat or protective coat need be applied.

The object of the invention is further achieved by an article provided with a coating comprising a pearlescent pigment as defined in any one of claims 1 to 27.

According to one preferred development of the invention, said article is a vehicle body, preferably a motor vehicle body, or an architectural facing, for example, a facing element.

The examples below illustrate the invention without restricting it thereto.

### EXAMPLE 1

100 g of glass flakes supplied by Glassflake Ltd. having an average thickness of approx. 300 nm (WO2004/056716A1) were coated with TiO₂, after being precoated with oxidic Sn-compounds, until the appearance of a blue interference color occurred. The filtercake was calcined immediately at 650° C. and a very lustrous effect pigment with a blue interference color was obtained.

### EXAMPLE 2

### Variant A

100 g of glass flakes coated with TiO₂ as obtained in Example 1 were suspended in 300 ml of isopropanol and the suspension was brought to the boil. With stirring, a solution of 0.45 g of ethylenediamine in 9.5 g of H₂O was added. Thereafter, over a period of 2 h, a solution of 17.5 g of tetraethoxysilane in 15 g of isopropanol was introduced continuously via a metering pump (Ismatec). The suspension was then left to react for 6 h. Then 0.6 g of Dynasylan AMEO and 1.3 g of Dynasylan 9116 were added and the mixture was left to cool slowly. It was stirred at room temperature overnight and subjected to suction filtration the next day. The pigment filtercake was subsequently dried in vacuo at 100° C. over a period of 6 h. The pigment had a theoretical SiO₂ content of 4.9% by weight.

### EXAMPLE 3

### Variant B

100 g of glass flakes coated with TiO₂ (obtained as in Example 1) were suspended in 300 ml of isopropanol and the suspension was brought to the boil. With stirring, first 2.0 g of H₂O and then, during the course of one hour, a solution of 2.17 g of cerium nitrate hexahydrate in 100 g of isopropanol were added. This was followed by the addition of a solution of 0.45 g of ethylenediamine in 3.0 g of H₂O. Thereafter, over a period of 2 h, 10.6 g of tetraethoxysilane and 22 g of isopropanol were introduced continuously via a metering pump (Ismatec). Thereafter, the suspension was left to react over a period of 6 h. Then 0.4 g of Dynasylan AMEO and 1.3 g of Dynasylan 9116 were added and the mixture was left to cool slowly. It was stirred at room temperature overnight and subjected to suction filtration the next day. The pigment filtercake was subsequently dried in vacuo at 80° C. The pigment had a theoretical Ce content of 0.7% by weight and an SiO₂ content of 3.0% by weight.

### EXAMPLE 4

### Variant B

100 g of glass flakes coated with TiO₂ (obtained as in Example 1) were suspended in 300 ml of ethanol, and the suspension was brought to the boil. With stirring, first 20 g of water and then, during the course of one hour, a solution of 2.2 g of cerium nitrate hexahydrate in 10 g of water was added. This was followed by the addition of a solution of 2.0 g of ammonia (25% by weight strength) in 8.0 g of water. Thereafter, over a period of 2 h, 10.6 g of Geniosil XL 926 and 0.4 g of Dynasylan AMEO were added, and the mixture was left to cool slowly. It was stirred at room temperature overnight and the solid was filtered off the next day. The pigment filtercake was subsequently dried overnight in vacuo at 80° C. The product had a theoretical cerium content of 0.7% by weight and an SiO₂ content of 3.0% by weight.

### COMPARATIVE EXAMPLE 5

Commercially available Exterior CFS Mearlin Super Blue 6303Z (10-40 μm) supplied by Engelhard.

### COMPARATIVE EXAMPLE 6

Prepared as in Example 1, but without the use of aminosilane. Aftercoating took place with only 1.7 g of Dynasylan 9116.

The examples relating to the invention and the comparative examples were subjected to various tests relating to weather stability and to UV stability. The test methods are described below and the results listed.

### A Condensation Water Climate Test

A number of pigment samples were incorporated in a water-based paint system and the test applications were produced by spray-coating. The basecoat was overcoated with a commercial one-component clearcoat and then baked. These applications were tested as specified in DIN 50 017 (standard damp heat atmosphere). The adhesive strength was tested by means of cross cutting as specified in DIN EN ISO 2409 immediately on conclusion of the test and one hour later and compared with the unstressed sample. In this test, Gt 0 denotes “no change” and Gt 5 “very severe change”. The degree of swell was assessed visually immediately following condensation stress, using a method based on DIN 53 230. Here, the index 0 denotes “no change” and the index 5 denotes “very severe change”. The degree of bubbling was assessed visually as specified in DIN 53 209. Here again, the score ranges from 0 (“very good”) to 5 (“very poor”). “m” denotes the frequency and “g” the size of the bubbles. Finally, the DOI (distinctness of image) was assessed visually. This may vary substantially on account of swelling caused by water retention (0=very good, 5=very poor).

TABLE 1
Condensation and cross cutting tests

| | Cross cutting Test | | | Degree of | Degree of | DOI | |
|---|---|---|---|---|---|---|---|
| Sample | 0-sample | 0 h | 1 h | bubbling | swell | 0 h | 1 h |
| Example 2 | Gt 0 | Gt 0 | Gt 0 | m1/g1 | 2 | 2 | 2 |
| Example 3 | Gt 0 | Gt 0 | Gt 0 | m1/g1 | 2 | 2 | 2 |
| Example 4 | Gt 0 | Gt 0 | Gt 0 | m1/g1 | 2 | 1 | 1 |
| Comparative | Gt 1 | Gt 2 | Gt 1 | m1/g1 | 2 | 2 | 1 |
| Example 5 | | | | | | | |
| Comparative | Gt 1 | Gt 4 | Gt 2 | m2/g3 | 2 | 2 | 2 |
| Example 6 | | | | | | | |

Examples 2, 3, and 4 relating to the invention are comparable in every respect to the prior-art Comparative Example 5, and pass the condensation test. Comparative Example 6, where the aftercoating consisted merely of an alkylsilane (16 carbons) without a functional group that binds to the paint system, however, is markedly poorer in terms of its adhesive strength in cross-cut, and fails the test.

With this sample, therefore, no further stress tests, such as the WOM test, were conducted.

### B WOM Test

The pigment samples were incorporated in a water-based paint system and the test applications were produced by spray-coating. The basecoat was overcoated with a commercial clearcoat and then baked. The accelerated weathering test took place as specified in SAE-J 1960 in an Atlas Ci-65 A Xeno-test apparatus having a water-cooled 6.5 kW xenon radiator.

The determination of the ΔE indices and also the gray scale rating took place in each case relative to the corresponding unstressed sample.

WOM tests are generally regarded, among all accelerated weathering methods, as being those which exhibit the best correlations to Florida weathering tests. Passing a Florida test is a prerequisite, for example, for a coating to be approved for the automobile sector. 4000 h in the WOM test correspond approximately to the requisite two-year Florida test.

### C UV Stability in Drawdowns

This test was carried out analogously to the UV test described in EP 0 870 730 for determining the photochemical UV activity of TiO₂ pigments.

For this purpose, 1.0 g of the pearlescent pigment was dispersed in 9.0 g of a melamine-containing paint rich in double bonds. Drawdowns were prepared on cardboard-backed paper, and were dried at room temperature. The drawdowns were cut in two and in each case one of the two sections was stored in the dark as an unstressed sample for comparison purposes. Subsequently, the samples were irradiated with UV-containing light (UV-A-340 lamp, irradiation level 1.0 W/m²/nm) in a QUV apparatus supplied by Q-Panel for 150 minutes. Immediately on conclusion of the test, calorimetric values of the stressed test samples relative to the respective control sample were determined using a Minolta CM-508i calorimeter. The resultant ΔE* indices, calculated according to the Hunter L*a*b* formula, are listed in Tab. 2.

In the test, a substantially gray-blue discoloration of the TiO₂ layer of the pearlescent pigment is observed in the drawdowns, owing to Ti(III) centers being formed under the influence of UV light. The condition for this to occur is that the electron hole has departed from the TiO₂ and—as a result of, say, reaction with olefinic double bonds in the binder—is unable to immediately recombine with the remaining electron. Since a melamine-containing paint layer significantly slows down the diffusion of water (vapor) and oxygen to the pigment surface, reoxidation of the titanium(III) centers takes place in a distinctly retarded fashion, so that the degree of graying can be measured and the ΔE* index can be employed as a measure of the light stability of the pigments. Thus the higher the numerical value of the ΔE* index for the stressed sample relative to the unstressed control sample, the poorer the light stability of the pigment under investigation.

When this test is used in examples relating to the invention, it is necessary to differentiate between samples subjected to and those not subjected to organic surface modification (OSM).

With organic surface modification, the pigment surface is isolated at least partly from the reactive, unsaturated melamine system. Consequently, the redox reaction vital for the formation of the chromophoric Ti(III) centers may not take place with the same efficacy and speed as in the first-named case. Consequently, in the case of pigments that have been subjected to organic surface modification, far less discoloration may be found. This does not mean, however, that the UV-catalytic activity is low in this case. In all cases, however, the ΔE* indices for a pearlescent pigment of the invention which has not undergone organic modification are thus somewhat higher than for the samples that have been surface-modified.

TABLE 2
WOM and UV drawdown test results

| | WOM | | UV test | |
|---|---|---|---|---|
| | test | Gray | ΔE* | ΔE* |
| Sample | ΔE* | scale | (no OSM) | (with OSM) |
| Example 2 | | | 2.1 | 1.0 |
| 500 h | 0.2 | 5 | | |
| 1000 h | 0.2 | 5 | | |
| 2000 h | 0.3 | 5 | | |
| 3000 h | 0.3 | 4-5 | | |
| 4000 h | 0.4 | 4-5 | | |
| Example 3 | | | 2.6 | 1.4 |
| 500 h | 0.1 | 5 | | |
| 1000 h | 0.2 | 5 | | |
| 2000 h | 0.2 | 5 | | |
| 3000 h | 0.2 | 4-5 | | |
| 4000 h | 0.4 | 4-5 | | |
| Example 4 | | | 2.1 | 1.5 |
| 500 h | 0.1 | 5 | | |
| 1000 h | 0.2 | 5 | | |
| 2000 h | 0.2 | 5 | | |
| 3000 h | 0.2 | 5 | | |
| 4000 h | 0.3 | 4-5 | | |
| Comparative Example 5 | | | — | 2.3 +/− 0.3 |
| (Exterior CFS Mearlin | | | | |
| Super Blue 6303Z) | | | | |
| 500 h | 0.4 | 5 | | |
| 1000 h | 0.5 | 5 | | |
| 2000 h | 0.8 | 4-5 | | |
| 3000 h | 0.8 | 4-5 | | |
| 4000 h | 1.0 | 4 | | |

OSM: Organic surface modification

When the color changes ΔE* in the WOM test on the blue pigments of Examples 2, 3, and 4 of the invention are compared with the same results obtained in Comparative Example 5 representative of the prior art, lower values and hence better weather resistances are found. Similar results apply to the light stabilities determined in the drawdown test. These results are particularly remarkable, since in this case only one single oxidic layer was used to stabilize the pearlescent pigments.

The pearlescent pigments of the invention are therefore capable of improving the weather and UV stabilities using only one single SiO₂ layer when set against comparative examples from the prior art

### UV Stability:

For closer investigation of the architecture of the oxide layer and the effect of the SiO₂ layer thickness, further examples relating to the invention and comparative examples were carried out and investigated in a drawdown test for their UV stability. In this case, an aftercoat was not applied, since aftercoating falsifies the UV test (see above).

### EXAMPLES 7 AND 8

100 g of glass flakes coated with TiO₂ as obtained in Example 1 were suspended in 300 ml of isopropanol, and the suspension was brought to the boil. With stirring, first 2.0 g of water and then, during the course of one hour, a solution of 0.93 g of Ce(NO₃)₃×6H₂O in 8 g of isopropanol was added. This was followed by the addition of a solution of 0.45 g of ethylenediamine in 3.0 g of H₂O. Thereafter, over a period of 2 h, a defined amount of tetraethoxysilane (see Table 3) and 22 g of isopropanol were introduced continuously using a metering pump (Ismatec). Thereafter, the suspension was allowed to react for 6 h. It was stirred at room temperature overnight and subjected to suction filtration the next day. The pigment filtercake was subsequently dried in vacuo at 100° C. for 6 h. Different amounts of SiO₂ were deposited in a similar way (see Table 3).

### EXAMPLES 9 And 10

For comparison, different protective layers with varying SiO₂ contents were also produced, without cerium salts being additionally deposited.

### EXAMPLE 11

Similarly, a comparative example with a cerium-containing protective layer (0.3% Ce content) was carried out, without SiO₂ being additionally deposited.

The ΔE* values of all of the examples were determined on drawdowns using the UV stability test described above. The amounts of chemicals employed, theoretical contents of protective layer components, and the ΔE* indices are listed in Table 3.

### EXAMPLES 12 AND 13

### Mixed Layer

100 g of glass flakes coated with TiO₂ as obtained in Example 1 were suspended in 300 ml of isopropanol, and the suspension was brought to the boil. With stirring, first 2.0 g of H₂O and then a solution of 0.45 g of ethylenediamine in 3.0 g of H₂O were added. Thereafter, over a period of 2 h, a solution of tetraethoxysilane (see Table 3) in 100 g of isopropanol and simultaneously a solution of 0.93 g of Ce(NO₃)₃×6H₂O in 100 g of isopropanol were introduced continuously using a metering pump (Ismatec). Subsequently the suspension was left to react for 6 h. The mixture was stirred at room temperature overnight and subjected to suction filtration the next day. The pigment filtercake was subsequently dried in vacuo at 80° C.

Different amounts of SiO₂ were deposited in a similar way (see Table 3).

### COMPARATIVE EXAMPLES 14 AND 15

Comparative Examples 14 and 15 were prepared as specified in the coating method described for Examples 8 and 9, but here first the silicate compound and then the cerium salt were introduced and precipitated.

TABLE 3
UV drawdown test results

| | | | Amount of | |
|---|---|---|---|---|
| | | | tetraethoxysilane | |
| Sample | Layer 1 | Layer 2 | used | ΔE* |
| Example 7 | 0.3% Ce | 1% SiO₂ | 3.47 g | 1.4 |
| Example 8 | 0.3% Ce | 2% SiO₂ | 6.94 g | 0.9 |
| Comparative | — | 1% SiO₂ | 3.47 g | 5.6 |
| Example 9 | | | | |
| Comparative | — | 2% SiO₂ | 6.94 g | 3.0 |
| Example 10 | | | | |
| Comparative | 0.3% Ce | — | — | 8.5 |
| Example 11 | | | | |
| Comparative | 0.3% Ce/1% SiO₂ | — | 3.47 g | 3.2 |
| Example 12 | | | | |
| Comparative | 0.3% Ce/2% SiO₂ | — | 6.94 g | 2.1 |
| Example 13 | | | | |
| Comparative | 1% SiO₂ | 0.3% Ce | 3.47 g | 5.9 |
| Example 14 | | | | |
| Comparative | 2% SiO₂ | 0.3% Ce | 6.94 g | 3.2 |
| Example 15 | | | | |

Table 3 clearly shows that a layer sequence of 1) cerium oxide and/or hydrated cerium oxide and/or cerium hydroxide and 2) SiO₂ provides the best UV stability. Pearlescent pigments protected only with SiO₂, and also pearlescent pigments protected only with cerium oxide and/or hydrated cerium oxide and/or cerium hydroxide, or having the layer sequence 1) SiO₂, 2) cerium oxide and/or hydrated cerium oxide and/or cerium hydroxide have significantly lower stabilities by comparison. Likewise, mixed layers of SiO₂ and cerium oxide and/or hydrated cerium oxide and/or cerium hydroxide exhibit a lower stabilized effect. These findings are a clear indication of the synergetic effects of a combined, successively precipitated cerium hydroxide coating and an SiO₂ coating, which only become effective if the cerium oxide and/or hydrated cerium oxide and/or cerium hydroxide layer is first precipitated, to be followed by precipitation of the silicon oxide layer.

### EXAMPLE 16

The luster properties of glass flakes coated with a cerium oxide layer and an SiO₂ layer as obtained in Example 1 are compared below with pearlescent pigments not having the oxidic protective layers of Example 1.

For this purpose, the pearlescent pigments of Example 1 having a layer of cerium oxide and a layer of SiO₂ (see Example 3) and those not having an aftercoat are incorporated in a commercially available NC paint system at a pigmentation level of 6% by weight based on the total weight of the paint. Drawdowns having a wet film thickness of 36 μm were prepared from the pigmented NC paint systems. The drawdowns were applied to test cards having a black and white background, as supplied by Byk Gardner, Germany, and then dried for 30 minutes at 25° C.

The luster was measured using a Micro-TRI-Gloss μ apparatus supplied by Byk Gardner, as specified in the manufacturer's instructions, using a measuring geometry of 60° in relation to the vertical. A measuring geometry of 60° is suitable for measuring the so-called “medium luster” in the range of from 10 to 70 luster points, higher numerical values of the luster points being indicative of higher luster. The measurement results are shown in Table 4.

TABLE 4
Luster values of Example 1 pigments
with and without an SiO₂ coating

| | 60° luster on | 60° luster on |
|---|---|---|
| Sample | white substrate | black substrate |
| Example 1 with cerium oxide | 25.6 | 20.3 |
| and SiO₂ coating (Example 3) | | |
| Example 1 with no aftercoat | 25.8 | 20.1 |

Table 4 shows that the coating of pearlescent pigments comprising a layer of cerium oxide and a layer of SiO₂ of poor refractive index, results, surprisingly, in an improvement in luster. Given the poor refractive index of SiO₂, it would have been expected that the pearlescent pigments coated with SiO₂ would have markedly lower luster properties than the pigments of Example 1.

1. Weather-stable pearlescent pigments based on a glass flake coated with highly refractive metal oxides and having a protective coat on the top metal oxide layer, wherein
said glass flake has an average thickness of from 50 nm to 500 nm, to which there is applied
A) a metal oxide layer having a refractive index n greater than 1.8 and containing TiO₂ having a rutile content of from 80% to 100% by weight and a protective coat of SiO₂
or
B) a metal oxide layer having a refractive index n greater than 1.8 and containing TiO₂ having a rutile content of from 80% to 100% by weight and a protective coat comprising a first protective coating containing at least one of cerium oxide and hydrated cerium oxide and cerium hydroxide and a second protective coating of SiO₂, and wherein
an organochemical surface coating is applied to the SiO₂ layer in the protective coats in A) or B).

2. The weather-stable pearlescent pigments as defined in claim 1, wherein
said glass flakes exhibit an average thickness of from 60 nm to 350 nm.

3. The weather-stable pearlescent pigments as defined in claim 1,
wherein
said SiO₂ layer is not a calcined oxide layer.

4. The weather-stable pearlescent pigments as defined in claim 1,
wherein
said SiO₂ layer has an average thickness of from 1 nm to 50 nm.

5. The weather-stable pearlescent pigments as defined in claim 1,
wherein
said SiO₂ layer contains from 0.5% to 10% by weight of SiO₂, based on the total weight of the pearlescent pigment.

6. The weather-stable pearlescent pigments as defined claim 1,
wherein
the organochemical surface coating comprises one or more silanes or at least one of cerium oxide and hydrated cerium oxide and cerium hydroxide and SiO₂.

7. The weather-stable pearlescent pigments as defined in claim 1,
wherein
said SiO₂ layer having at least one of organofunctional silanes, aluminates, zirconates, and titanates is surface-modified.

8. The weather-stable pearlescent pigments as defined in claim 6
wherein
said silane surface coating is not a mixture of AMMO and GLYMO.

9. The weather-stable pearlescent pigments as defined in claim 6,
wherein
the silane used for surface coating is a silane which is insoluble or poorly soluble in water.

10. The weather-stable pearlescent pigments as defined in claims 1,
wherein
the organochemical surface coating is covalently bonded to said protective coat.

11. The weather-stable pearlescent pigments as defined in claim 7, wherein said organofunctional silanes comprise at least one silane having at least one functional binding group.

12. The weather-stable pearlescent pigments as defined in claim 7, wherein said organofunctional silanes comprise at least one silane having at least one functional binding group and at least one silane not containing a functional binding group.

13. The weather-stable pearlescent pigments as defined in claim 11,
wherein
said at least one functional binding group is selected from the group consisting of acrylate, methacrylate, vinyl, amino, cyanate, isocyanate, epoxy, hydroxy, thiol, ureido and carboxyl groups and mixtures thereof.

14. The weather-stable pearlescent pigments as defined in claim 11,
wherein
said silane containing at least one functional binding group is an aminosilane.

15. The weather-stable pearlescent pigments as defined in claim 11,
wherein
said silane containing at least one functional binding group is a monomer.

16. The weather-stable pearlescent pigments as defined in claim 11, wherein
said at least one silane having at least one functional binding group is a silane prehydrolyzed to an extent of not more than 50%.

17. The weather-stable pearlescent pigments as defined in claim 12,
wherein
said at least one silane not containing a functional binding group is an organofunctional silane which is insoluble or poorly soluble in water.

18. The weather-stable pearlescent pigments as defined in claim 17,
wherein
said silane not containing a functional binding group is an alkylsilane.

19. The weather-stable pearlescent pigments as defined in claim 17,
wherein
the silane not containing a functional binding group exhibits the structural formula (II),
(R¹—X-[A-Y]ₙ—B)_{(4-z)}Si(OR²)_{z} (II)
in which
n denotes 1 to 100,
z is an integer from 1 to 3,
R¹ stands for linear or branched alkyl containing from 1 to 12 carbons, which can be substituted by halogens; aryl containing from 6 to 12 carbons; or aryl containing from 6 to 12 carbons, which can be substituted by alkyl containing from 1 to 6 carbons and/or by halogens,
R² stands for linear or branched alkyl containing from 1 to 6 carbons
A and B independently stand for a divalent group comprising linear or branched alkylene containing from 1 to 12 carbons; arylene containing from 6 to 12 carbons; or arylene containing from 6 to 12 carbons, which can be substituted by alkyl containing from 1 to 6 carbons and/or by halogens; and
X and Y independently stand for O or S.

20. The weather-stable pearlescent pigments as defined in claim 19,
wherein
R¹ and R² are independently selected from the group consisting of methyl, ethyl, n-propyl, isopropyl, n-butyl, isobutyl, tert-butyl, phenyl, biphenyl, napthyl, and mixtures thereof.

21. The weather-stable pearlescent pigments as defined in claim 19,
wherein
A and B are independently selected from the group consisting of ethylene, propylene, 1-butylene, 2-butylene, phenylene, which can be substituted by alkyl containing from 1 to 6 carbons, and mixtures thereof.

22. The weather-stable pearlescent pigments as defined in claim 19,
wherein
said silanes are present in a pure state with a defined value of n or in mixtures with different values of n.

23. The weather-stable pearlescent pigments as defined in claim 7,
wherein
said surface modifying agents exist in monomeric, oligomeric, or polymeric form prior to application thereof to said SiO₂ layer.

24. Weather-stable pearlescent pigments as defined in claim 23,
wherein
said surface modifying agents exist in monomeric form prior to application thereof to said SiO₂ layer.

25. The weather-stable pearlescent pigments as defined in claim 1,
wherein
the fraction of cerium in the protective coat B is from 0.05% to 3.0% by weight, based on the total weight of the pigment.

26. The weather-stable pearlescent pigments as defined in claim 1,
wherein
the glass flake comprises one or more metal oxide layers, wherein the platelet-type substrate coated with the one or more metal oxide layers is preferably calcined.

27. A process for the preparation of weather-stable pearlescent pigments as defined in claim 1, comprising the following steps:
(a) creating a suspension of metal oxide-coated glass flakes in a liquid phase, in which the metal oxide has a refractive index greater than 1.8,
(b1) applying a protective coat of SiO₂ to the glass flakes suspended in step (a), or
(b2) applying a protective coat comprising a first protective coating of cerium oxide and/or hydrated cerium oxide and/or cerium hydroxide and a second protective coating of SiO₂ to the glass flakes suspended in step (a), and
(c) applying an organochemical surface coating to the top protective coating of SiO₂ produced in step (b1) or (b2).

28. The process as defined in claim 27,
wherein
the liquid phase in step (a) contains a predominant amount of organic solvent.

29. The process as defined in claim 27,
wherein
the at least one of cerium oxide and cerium hydroxide layer produced in step (b2) using cerium compounds soluble in organic solvents is applied with the optional addition of a base or acid.

30. The process as defined in claim 27,
wherein
in step (b1) or (b2), the SiO₂ layer is applied to the coated pigment with the addition of tetraalkoxysilane and with the optional addition of water.

31. The process as defined in claim 30,
wherein
the tetraalkoxysilane is selected from the group consisting of tetramethoxysilane, tetraethoxysilane, tetraisopropoxysilane, tetrabutoxysilane, and mixtures thereof.

32. The process as defined in claim 27,
wherein additional nitrogenous bases are added during the SiO₂ coating operation in step (b1) or (b2).

33. The process as defined in claim 27,
wherein
in step (c) the pigments provided with a SiO₂ layer are taken up in a liquid phase containing a predominant amount of organic solvent and are then surface coated by organochemical means.

34. The process as defined in claim 27,
wherein
in step (a) the glass flakes are suspended in water or in a predominantly aqueous medium
and
in step (b1) or (b2) the SiO₂ layer is applied using aqueous silicate solutions.

35. The process as defined in claim 28,
wherein
said organic solvent is selected from the group consisting of ethyl acetate, an alcohol such as methanol, ethanol, n-propanol, isopropanol, n-butanol, 2-methylpropanol, 2-methoxypropanol, butyl glycol, and mixtures thereof.

36. A method of making a composition selected from the group consisting of coatings, paints, powder-based paints, printing inks, plastics materials, and cosmetic preparations by incorporating therein an effective amount of weather-stable pearlescent pigment as defined in claim 1.

37. A method of making a composition selected from the group consisting of weather-resistant automobile lacquers, powder-based paints and coatings for weather-resistant exterior and architectural facing applications, by incorporating therein an effective amount of weather-stable pearlescent pigment as defined in claim 1.

38. An article, wherein said article is provided with a coating containing pearlescent pigments as defined in claim 1.

39. The object as defined in claim 38, wherein said article is a vehicle body or an architectural facing element.

40. The weather-stable pearlescent pigments as defined in claim 6, wherein the one or more silanes are present in said surface coating in an amount of from 0.1% to 6% by weight, based on the total weight of the pearlescent pigment coated with SiO₂.

41. The weather-stable pearlescent pigments as defined in claim 11, wherein said at least one silane having at least one functional binding group is a non-prehydrolyzed silane.

42. The weather-stable pearlescent pigments as defined in claim 18, wherein said alkylsilane is applied using an alkylsilane of the structural formula (I),
R_{(4-z)}Si(X)_{z}
in which
R is a substituted or unsubstituted, linear or branched alkyl chain containing from 10 to 22 carbon atoms,
X stands for a halogen and/or an alkoxy group and
z is an integer from 1 to 3.

43. The weather-stable pearlescent pigments as defined in claim 25, wherein the fraction of cerium in the protective coat B is from 0.1% to 1.0% by weight, based on the total weight of the pigment.

44. The weather-stable pearlescent pigments as defined in claim 25, wherein the fraction of cerium in the protective coat B is from 0.2% to 0.7% by weight, based on the total weight of the pigment.

45. The weather-stable pearlescent pigments as defined in claim 26, wherein the glass flake further comprises at least one layer of tin oxide.

46. The process as defined in claim 28, wherein the organic solvent contains less than 50% by weight of water.

47. The process as defined in claim 29, wherein the cerinium compounds soluable in organinic solvents are selected from the group consisting of cerium(III) acetate, cerium(III) octoate, cerium(III) acetylacetonate, cerium(III) nitrate, cerium(III) chloride, cerium(IV) ammonium nitrate, and mixtures thereof.

48. The process as defined in claim 34, wherein the aqueous silicate slution is water glass.
